(19) United States
(12) Patent Application Publication
(10) Pub. No.: US 2004/0069089 A1
(43) Pub. Date: Apr. 15, 2004

(54) Handle mounted bicycles derailleur controller

(76) Inventor: Po-Cheng Chen, Taipei (TW)

Correspondence Address: SUPREME PATENT SERVICES, POST OFFICE BOX 2339, SARATOGA, CA, 95070, US

(21) Appl. No.: 10/271,108

(22) Filed: Oct. 15, 2002

(51) Int. Cl. F16C 1/10

(52) U.S. Cl. 74/502.2

(57) ABSTRACT

A handle mounted bicycle derailleur controller is mounted to a bicycle handle bar for controlling a derailleur of the bicycle. The derailleur controller includes a casing including a cylindrical wall and a concentric hub fit over the handle bar. A number of teeth are mounted in a receiving space defined between the cylindrical wall and the hub. A rotation sleeve is rotatably fit over the hub and forms a slot to engage an expanded end of a cable whereby rotation of the sleeve leads to a change of the length of the cable which in turn causes gear shifting. The rotation sleeve includes a detent retainer integrally formed therewith. The detent retainer includes two opposite U-shaped portions open toward each other. A leaf spring has a substantially L-shaped body having first and second sections connected to each other by an angled connection serving as a detent and two free ends respectively and movably received in the U-shaped portions of the detent retainer. The detent is selectively engageable with valleys defined between the teeth for controlling the length change of the cable. A handle is fit over and rotatably fixed to the sleeve. Thus, a bicycle rider can rotate the handle to drive the sleeve for changing the length of the cable by engaging the detent with a desired one of the valleys of the teeth.

### FIELD OF THE INVENTION

The present invention relates generally to a bicycle derailleur controller, and especially to a derailleur controller that is mounted to a handle bar of the bicycle to allow for direct control of derailleur system without rider's hand removing from the handle bars to ensure stable riding.

### BACKGROUND OF THE INVENTION

Derailleur systems used presently on bicycles have different effects of gear shifting. No matter what types the derailleur is, the derailleur operates in accordance with the same principle of gear shifting by controlling the length of a speed control cable to change and control the relative positions between the chain and the gear set connected to the pedal of a bicycle. Bicycle derailleur systems that are currently available in the markets comprises a controller mounted on the bicycle at a location away from the handle bar of the bicycle and thus requiring a bicycle rider to move one of his hands away from the handle bar that the rider holds to make an action for gear shifting. A short period where the rider's hand is off the handle bar occurs. In this period of time, the bicycle gets inferior balance, shakes and even tilts to fall down.

U.S. Pat. No. 6,067,875 teaches a handle mounted derailleur controller that is mounted to a bicycle handle bar and allows for a rider's direct access without moving hand off the handle bar. Such a derailleur controller, however, has a complicated structure and requires a sophisticated assembly operation to put a great number of components together. Manufacturing costs and maintenance expenses are thus very high.

U.S. Pat. No. 6,209,413 discloses a simplified handle mounted derailleur controller, which has a structure much more simple than the device of U.S. Pat. No. 6,067,875. The derailleur controller comprises a spring-biased detent that selectively engages different teeth for gear shifting. The spring is arranged as a cantilever arm with the detent formed on the free end thereof. Due to the free movement of the detent, there is a potential risk that the detent goes out of engagement with the teeth, resulting to malfunction f the derailleur controller.

Thus, it is desired to have a handle mounted derailleur controller to overcome the problems encountered in the conventional handle mounted derailleur controller.

### SUMMARY OF THE INVENTION

The present invention is aimed to provide a bicycle derailleur controller that is mounted to a handle bar of the bicycle whereby a bicycle rider does not need to move his or her hand off the handle bar in shifting gears.

Another object of the present invention is to provide a handle mounted derailleur controller that allows for safe and smooth riding of a bicycle.

A further object of the present invention is to provide a handle mounted derailleur controller having a simple structure.

Yet a further object of the present invention is to provide a handle mounted derailleur controller that can be properly operated without failure to shift gears.

To achieve the above objects, in accordance with the present invention, there is provided a handle controlled bicycle derailleur controller adapted to be mounted to a bicycle handle bar for controlling a derailleur of the bicycle. The derailleur controller comprises a casing having a cylindrical wall and a concentric hub fit over the handle bar. A number of teeth are mounted in a receiving space defined between the cylindrical wall and the hub. A rotation sleeve is rotatably fit over the hub and forms a slot to engage an expanded end of a cable whereby rotation of the sleeve leads to a change of the length of the cable which in turn causes shifting of gears. The rotation sleeve comprises a detent retainer integrally formed therewith. The detent retainer comprises two opposite U-shaped portions open toward each other. A leaf spring has a substantially L-shaped body having first and second sections connected to each other by an angled connection serving as a detent and two free ends respectively and movably received in the U-shaped portions of the detent retainer. The detent is selectively engageable with valleys defined between the teeth for controlling the length change of the cable. A handle is fit over and rotatably fixed to the sleeve. Thus, a bicycle rider can rotate the handle to drive the sleeve for changing the length of the cable by engaging the detent with a desired one of the valleys of the teeth.

The bicycle derailleur of the present invention has the following advantages:

(1) A more accurate control of gear shifting can be obtained without potential risk of speed jumping with a simple structure and secured operation.

(2) Application of the derailleur controller to various grades of speed of bicycle can be done by simply replacing a toothed ring thereof.

(3) Safe riding is ensured because a bicycle rider does not need to move his or her hand off the handle bar of the bicycle.

(4) The derailleur controller has a simple structure that allows for ready mounting and replacement by a bicycle rider himself or herself. Costs can thus be reduced.

(5) No change of operation behavior of the bicycle rider is required because the derailleur controller is mounted to a handle bar of the bicycle and can be accessed by the rider's hand directly.

The present invention will be apparent after reading the detailed description of the preferred embodiment thereof with reference to the accompanying drawings, in which:

### BRIEF DESCRIPTION OF THE DRAWINGS

FIG. 1 is an exploded view of a derailleur controller constructed in accordance with the present invention;

FIG. 2 is a cross-sectional view of the derailleur controller, which is at a first speed setting;

FIG. 3 is a cross-sectional view of the derailleur controller, which is at a last speed setting; and

FIG. 4 is a perspective view showing the derailleur controller of the present invention mounted to a handle bar of a bicycle.

### DETAILED DESCRIPTION OF THE INVENTION

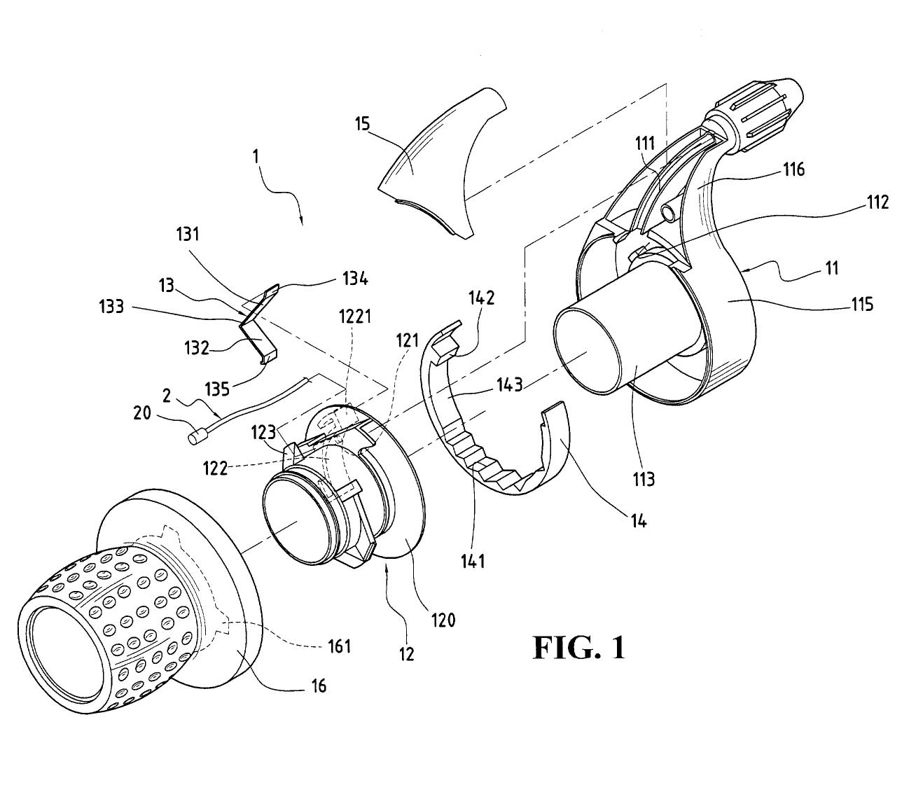

With reference to the drawings and in particular to FIG. 1, a handle mounted bicycle derailleur controller constructed in accordance with the present invention, generally designated with reference numeral 1, comprises a cylindrical casing 11 having a concentric hub 113 whereby a ring-shape receiving space 112 is defined between a cylindrical wall 115 of the casing 11 and the hub 113. A cable retainer 116 extends from the cylindrical wall 115 and defines a cable passage 111 therein. The cable passage 111 is in communication with the receiving space 112 for allowing a cable 2 for controlling a derailleur (not shown) to extend into the receiving space 112. The cable 2 forms an expanded fastener end 20 to be further described.

A semi-circular ring 14 is received and fixed in the receiving space 112. The ring 14 has an inner face 143 confronting the hub 113. A number of teeth 141 are formed on the inner face 143. The teeth 141 are triangular and have opposite inclined side faces (not labeled). The teeth 141 are arranged in consecutive form whereby adjacent side faces of adjacent triangular teeth 141 are connected to each other, forming a valley of a predetermined included angle, such as 90 degrees. A stop block 142 is also formed in the inner face 143 of the ring 14.

A rotation sleeve 12 is fit over and rotatably supported by the hub 113 of the casing 11. A circumferential flange 120 is formed on and surrounds one end of the sleeve 12. The flange 120 confronts a bottom (not labeled) of the receiving space 112 for interposing the semi-circular ring 14 therebetween. A manual control handle 16 having a substantially cylindrical configuration is fit over the sleeve 12. The handle 16 forms a number of notches 161 in an inside surface (not labeled) thereof for receiving and drivingly engaging a number of projections 123 formed on a side surface (not labeled) of the sleeve 12 whereby the rotation sleeve 12 is rotatably fixed to the handle 16 for being controlled by a bicycle rider.

The rotation sleeve 12 integrally forms a detent retainer 122 comprising two U-shaped sections 1221 open toward each other. A leaf spring 13 has an L-shaped body comprised of two sections 131, 132 connected to each other at a right-angled connection 133 that forms a detent. Each section 131, 312 has a free end 134, 135 movably received in the U-shaped sections 1221 of the detent retainer 122. The detent retainer 122 and the leaf spring 13 are arranged so that the detent 133 is engageable with the valleys (which has an included angle of 90 degrees in the embodiment illustrated) defined between the teeth 141 of the ring 14 for setting the derailleur at a corresponding gear of a gear set of the derailleur. The U-shaped sections 1221 of the detent retainer 122 are large enough to accommodate movement of the ends 134, 135 of the leaf spring 13 therein whereby movement of the detent 133 from one valley to another valley is not subject to constraints caused by the U-shaped sections 1221 of the detent retainer 122. However, since both ends 134, 135 are properly retained by the U-shaped sections 1221 of the detent retainer 122, the detent 133 can be effectively maintained in engagement with the teeth 141 and getting out of engagement with the teeth 141 can be effectively eliminated.

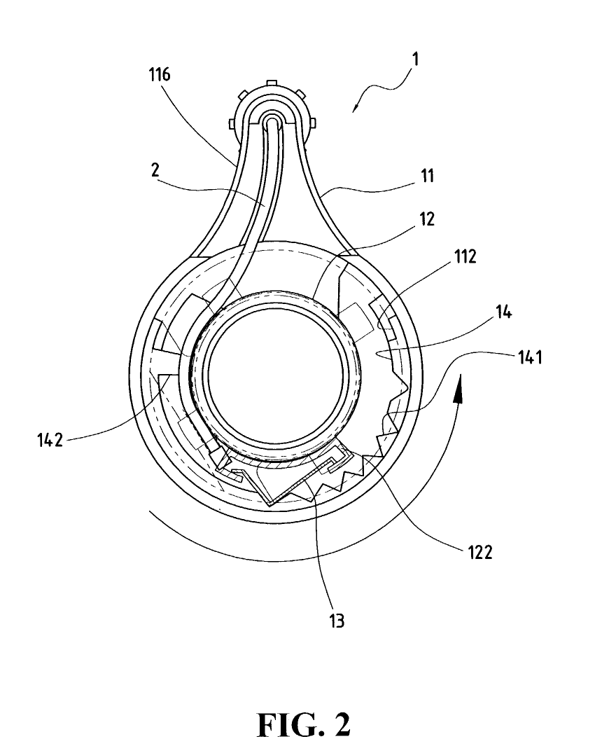

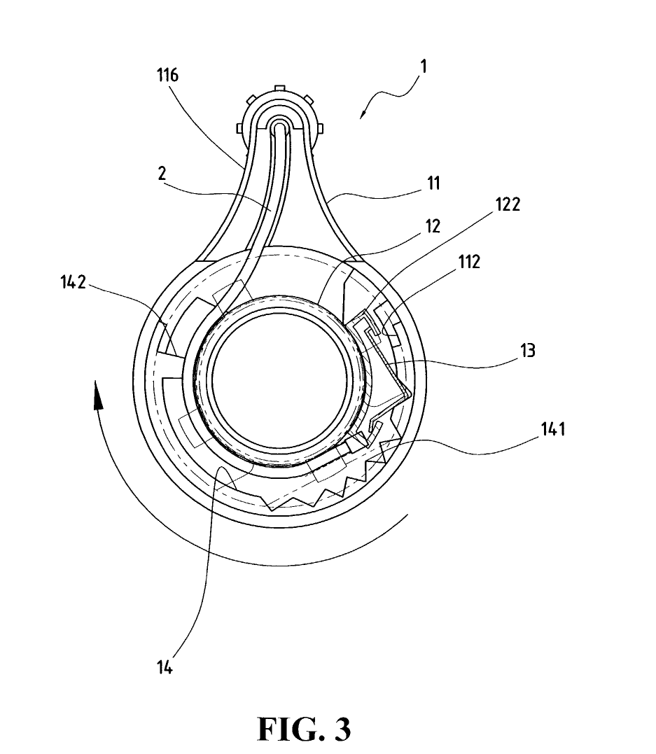

Also referring to FIGS. 2 and 3, by manually rotating the handle 16 as indicated by arrows shown in FIGS. 2 and 3, the sleeve 12 is caused to rotate about the hub 113 and drives the detent 133 to move from a first valley of the teeth 141 to a second one by deforming the leaf spring 13. The ends 134, 135 of the leaf spring 13 are free to move in the U-shaped sections 1221 of the detent retainer 122 when the leaf spring 13 is being deformed.

The sleeve 12 forms a slot 121 for receivingly engaging the fastener end 20 of the cable 2. When the sleeve 12 is rotated by the handle 16, the cable 2 is pulled and the length of the cable between the derailleur controller 1 and the derailleur is changed. Gear shifting is thus accomplished. Mounting the fastener end 20 of the cable 2 to the slot 121 defined in the sleeve 12 can be done with any know means and no further detail is needed herein.

The stop block 142 of the ring 14 engages a corresponding portion of the sleeve 12 to define a limit to the rotation of the sleeve 12. The corresponding portion is for example one of the U-shaped sections 1221 of the detent retainer 122. Or alternatively, one or two projections (not shown) can be formed on the sleeve 12 to engage the stop block 142 and stop the rotation of the sleeve 12.

In the embodiment illustrated, the cable passage 111 is formed in an open form. The cable 2 movably received in the passage 111 may accidentally get out of the passage 111. A protection cover 15 is provided and mounted to the cable retainer 116 for covering the passage 111 and thus securely retaining the cable 2 in the passage 111.

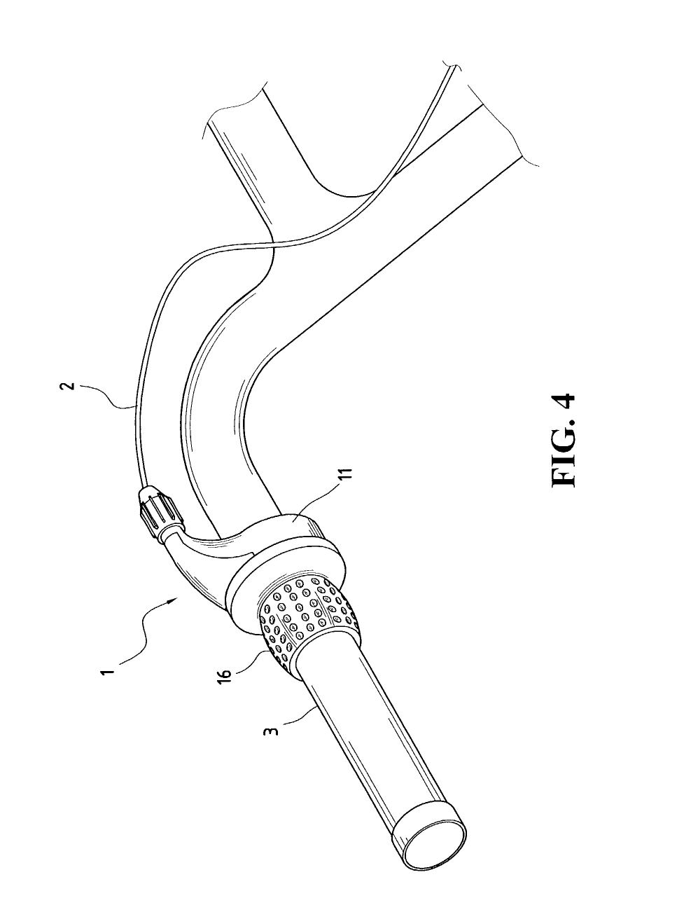

Also referring to FIG. 4 the derailleur controller 1 of the present invention is mounted to a handle bar 3 of a bicycle with the handle bar 3 extending through the hub 113 of the casing 11 and the handle 16. Thus, a bicycle rider can directly access the derailleur controller 1 to do gear shifting without removing his or her hand from the handle bar 3. Since the control of the cable 2 in the handle mounted bicycle derailleur controller 1 of the present invention is effected by driving the rotation sleeve 12 with the handle 16 and since the handle 16 is located in a location that can be directly accessed by the thumb and the index finger of the rider's hand, the rider can directly rotate the handle 16 with his or her hand without removing his or her hand from the bicycle handle bar 3. In addition, mounting the derailleur controller 1 to the handle bar 3 does not influence the rider's posture or habit in holding the handle bar 3.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A bicycle derailleur controller adapted to be mounted to a bicycle handle bar for controlling a derailleur of the bicycle, the derailleur controller comprising:
a casing comprising a cylindrical wall and a concentric hub fit over the handle bar, a number of teeth being mounted in a receiving space defined between the cylindrical wall and the hub;
a rotation sleeve rotatably fit over the hub and forming a slot to engage an expanded end of the cable whereby rotation of the sleeve causes a change to length of the cable, the rotation sleeve comprising a detent retainer integrally formed therewith, the detent retainer comprising two opposite U-shaped portions open toward each other; and
a leaf spring comprising a substantially L-shaped body having first and second sections connected to each other by an angled connection serving as a detent and two free ends respectively and movably received in the U-shaped portions of the detent retainer, the detent being selectively engageable with valleys defined between the teeth for controlling the length change of the cable.

2. The derailleur controller as claimed in claim 1, further comprising a substantially cylindrical handle fit over and rotatably mounted to the sleeve whereby the sleeve is rotatable in unison with the handle.

3. The derailleur controller as claimed in claim 1, wherein the casing comprises a cable retainer extending from the cylindrical wall, a cable passage being defined in the cable retainer and in communication with the receiving space of the casing for movable extension of the cable therethrough.

4. The derailleur controller as claimed in claim 3, further comprising a protection cover attached to the cable retainer to retain the cable in the passage.

5. The derailleur controller as claimed in claim 1, wherein the casing forms at least one stop block for engaging a corresponding projection of the sleeve to limit the rotation of the sleeve.

6. The derailleur controller as claimed in claim 2, wherein the sleeve forms a number of projections received and drivingly engaging notches defined in an inside face of the handle.

7. The derailleur controller as claimed in claim 1, wherein the teeth are formed on a semi-circular member received in the receiving space.
